(19) United States
(12) Patent Application Publication
(10) Pub. No.: US 2025/0368584 A1
(43) Pub. Date: Dec. 4, 2025

(54) ORGANIC FERTILIZER MANUFACTURING SYSTEM

(71) Applicant: BSAC CO., INC., Gwangyang-si (KR)

(72) Inventors: Kwang Gi PARK, Gwangyang-si (KR); Hoi Jun PARK, Gwangyang-si (KR)

(21) Appl. No.: 18/736,513

(22) Filed: Jun. 6, 2024

(30) Foreign Application Priority Data
Jun. 3, 2024 (KR) 10-2024-0072328

(51) Int. Cl. C05F 11/08; C05G 5/12; C05G 5/30

(52) U.S. Cl. CPC C05F 11/08; C05G 5/12; C05G 5/30

(57) ABSTRACT

An embodiment of the present invention provides an organic fertilizer manufacturing system, which includes: a pellet manufacturing module configured to manufacture fertilizer pellets from a plurality of hoppers storing different raw materials; and a fertilizer processing module configured to process the fertilizer pellets supplied from the pellet manufacturing module to manufacture organic fertilizer, wherein a fertilizer processing unit provided in the fertilizer processing module is configured to manufacture the organic fertilizer, and the organic fertilizer is selectively manufactured as granular fertilizer, coated granular fertilizer, pelleted fertilizer, and coated pelleted fertilizer.

### CROSS-REFERENCE TO RELATED APPLICATION

This application claims priority to and the benefit of Korean Patent Application No. 10-2024-0072328, filed on Jun. 3, 2024, the disclosure of which is incorporated herein by reference in its entirety.

### BACKGROUND

### 1. Field of the Invention

The present invention relates to an organic fertilizer manufacturing system, and more specifically, to an organic fertilizer manufacturing system configured to simply manufacture various types of organic fertilizer.

### 2. Discussion of Related Art

Fertilizers are nutritious substances that promote the growth and development of crops, plants, and trees by making the soil fertile.

In order to increase the productivity of crops, chemical fertilizers (inorganic fertilizers) are being used. These chemical fertilizers can promote the rapid growth of cultivated crops, but there is the problem in that the soil of the cultivation area is acidified and salt stress occurs due to salt accumulation. Such salt stress inhibits the growth and development of microorganisms which are the final decomposers.

Accordingly, organic fertilizers are being proposed instead of chemical fertilizers. The organic fertilizer is an organic compound-containing fertilizer and ionizes minerals in the soil so that the minerals are easily absorbed into crops. Such an organic fertilizer can increase soil quality by alleviating salt accumulation in the soil of the cultivation area.

However, when livestock excrement, waste containing organic matter, or a plant material, which are raw materials for organic fertilizers, is used as a fertilizer as it is, there is difficulties in storage and use. Therefore, the organic fertilizer is used after being manufactured in the form of a solidified fertilizer.

Accordingly, research and development is being actively conducted on an organic fertilizer manufacturing system configured to more simply manufacture solidified organic fertilizers.

### SUMMARY OF THE INVENTION

The technical objective of the present invention to solve the above problems is to provide an organic fertilizer manufacturing system configured to simply manufacture various types of organic fertilizer.

In order to achieve the technical objective, one aspect of the present invention provides an organic fertilizer manufacturing system which includes: a pellet manufacturing module configured to manufacture fertilizer pellets from a plurality of hoppers storing different raw materials; and a fertilizer processing module configured to process the fertilizer pellets supplied from the pellet manufacturing module to manufacture organic fertilizer, wherein a fertilizer processing unit provided in the fertilizer processing module is configured to manufacture the organic fertilizer, and the organic fertilizer is selectively manufactured as granular fertilizer, coated granular fertilizer, pelleted fertilizer, and coated pelleted fertilizer.

In an embodiment of the present invention, the fertilizer processing unit may include: a cylindrical rotary housing provided with an inlet configured to introduce the fertilizer pellets supplied from the pellet manufacturing module at one end and an outlet configured to discharge the selectively processed organic fertilizer at the other end; mixing wings provided at predetermined intervals along the circumferential direction and longitudinal direction of the cylindrical rotary housing; a coating liquid supply unit coupled to one end of the cylindrical rotary housing and configured to spray a coating liquid inside the cylindrical rotary housing; a hot air supply unit coupled to one end of the cylindrical rotary housing and configured to supply hot air into the cylindrical rotary housing; and an operation control unit configured to control the operation of the coating liquid supply unit and the hot air supply unit.

In an embodiment of the present invention, the operation control unit may be configured to control the operation of the coating liquid supply unit so that a desired microorganism coating liquid is sprayed onto the fertilizer pellets and the outer surface of the organic fertilizer is coated with microorganisms.

In an embodiment of the present invention, the operation control unit may be configured to control the operation of the hot air supply unit so that the temperature and intensity of hot air supplied to the fertilizer pellets are adjusted and the organic fertilizer with a desired form is manufactured.

In an embodiment of the present invention, the coating liquid supply unit may include: coating liquid tanks each accommodating a different microorganism coating liquid; a spray nozzle disposed in a processing space accommodating the fertilizer pellets in the cylindrical rotary housing and configured to spray the microorganism coating liquid supplied from the coating liquid tank into the processing space; and a metering pump connected to the coating liquid tank and configured to supply the microorganism coating liquid accommodated in the coating liquid tank to the spray nozzle, and the operation control unit may be configured to control the supply of the microorganism coating liquid from each coating liquid tank to the spray nozzle.

In an embodiment of the present invention, the spray nozzle may be disposed at one end of the cylindrical rotary housing, and the length of the spray nozzle may be ⅓ or less of the length of the cylindrical rotary housing.

In an embodiment of the present invention, the pellet manufacturing module may include: a metering ejector configured to supply raw materials to a plurality of hoppers storing different raw materials; a pulverizer configured to pulverize the raw materials supplied from the hopper; a mixer configured to mix the raw materials pulverized by the pulverizer; a steamer configured to supply moisture to the raw materials mixed by the mixer; and a shaping machine configured to shape the raw materials supplied from the steamer into the fertilizer pellets, and the fertilizer processing module may further include: a blower unit configured to cool the organic fertilizer manufactured by the fertilizer processing unit; and a packaging machine configured to package the organic fertilizer supplied from the blower unit.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows a block diagram of an organic fertilizer manufacturing system according to an embodiment of the present invention;

FIG. 2 shows a schematic diagram of a shaping machine in which an outer housing according to an embodiment of the present invention is closed;

FIG. 3 shows a schematic diagram of a shaping machine in which an outer housing according to an embodiment of the present invention is open;

FIG. 4 shows a block diagram of a fertilizer processing unit according to an embodiment of the present invention;

FIG. 5 shows a schematic diagram of a fertilizer processing unit according to an embodiment of the present invention; and

FIG. 6 shows a schematic diagram of the cross-section cut along line A-A of FIG. 5.

### DETAILED DESCRIPTION OF EXEMPLARY EMBODIMENTS

Hereinafter, the present invention will be described with reference to the accompanying drawings. However, it should be understood that the descriptions of the present invention can be implemented in various other forms, and that it is not intended to limit the present invention to the exemplary embodiments. Also, in the drawings, descriptions of parts unrelated to the detailed description are omitted to clearly describe the present invention. Throughout the specification, like numbers refer to like elements.

Throughout the specification, when a certain part is said to be “connected” to another part, this includes not only cases where the certain part is “directly connected” to the other part but also cases where it is “indirectly connected” to the other part through another member interposed between the two parts. Also, when a certain part is said to “include” a certain element, this does not mean that other elements are excluded, but that other elements may be additionally provided, unless specifically indicated otherwise.

In the present invention, the upper and lower portions mean that a component is located above or below the target member, and do not necessarily mean that a component is located above or below the target member based on the direction of gravity.

Hereinafter, embodiments of the present invention will be described in detail with reference to the accompanying drawings.

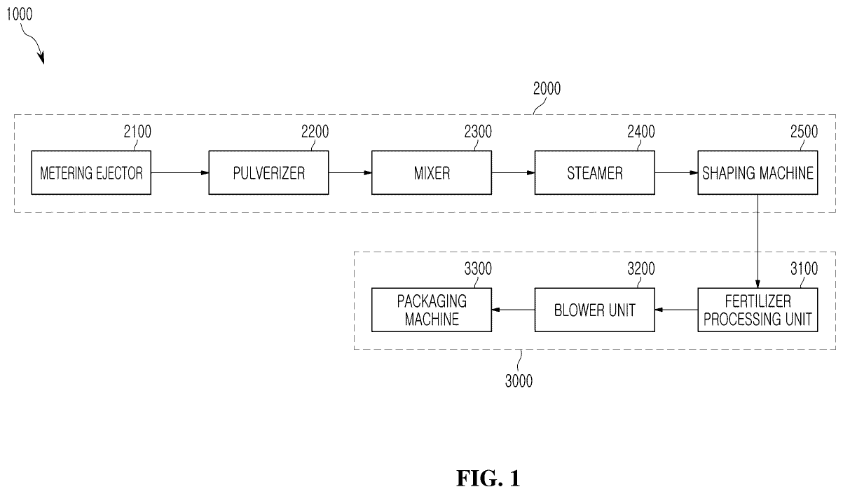

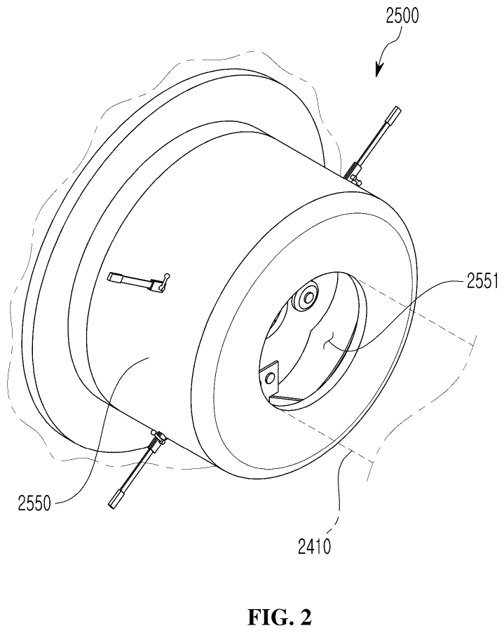

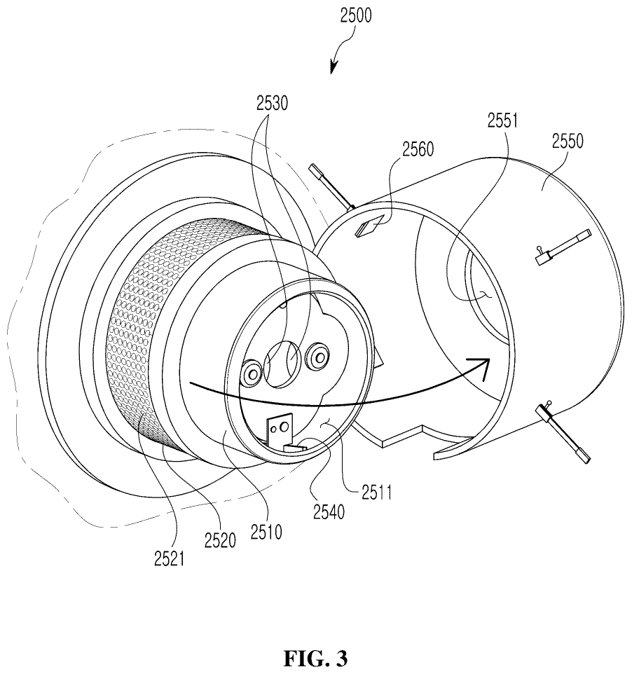

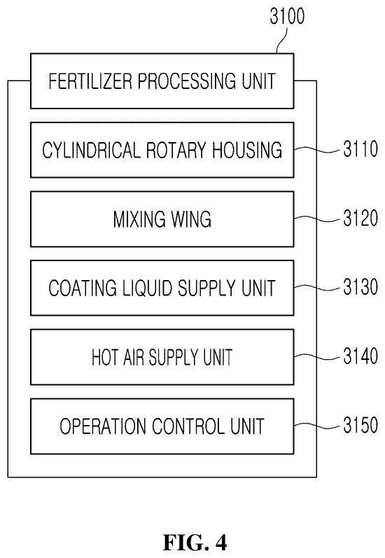

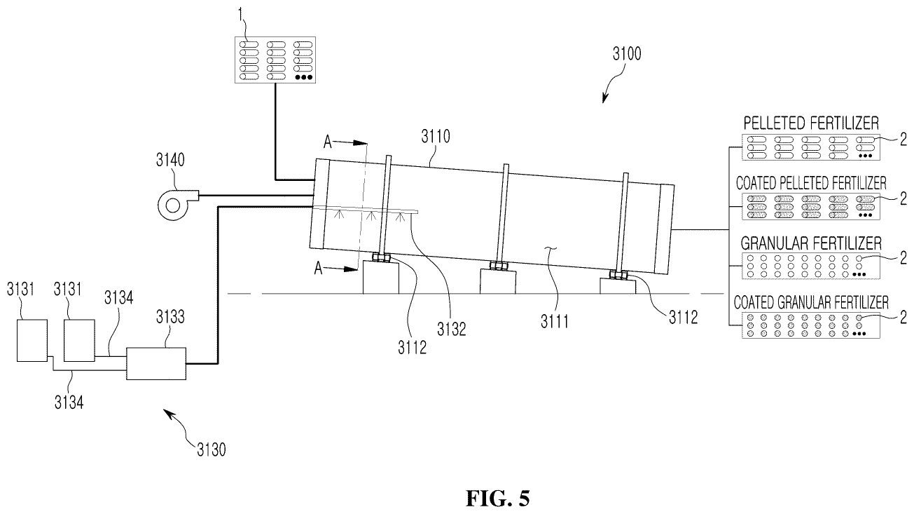

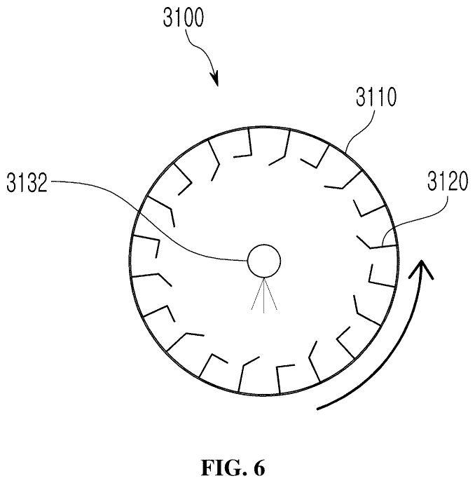

FIG. 1 shows a block diagram of an organic fertilizer manufacturing system according to an embodiment of the present invention, FIG. 2 shows a schematic diagram of a shaping machine in which an outer housing according to an embodiment of the present invention is closed, FIG. 3 shows a schematic diagram of a shaping machine in which an outer housing according to an embodiment of the present invention is open, FIG. 4 shows a block diagram of a fertilizer processing unit according to an embodiment of the present invention, FIG. 5 shows a schematic diagram of a fertilizer processing unit according to an embodiment of the present invention, and FIG. 6 shows a schematic diagram of the cross-section cut along line A-A of FIG. 5.

As shown in FIGS. 1 to 6, an organic fertilizer manufacturing system 1000 may include a pellet manufacturing module 2000 and a fertilizer processing module 3000.

The pellet manufacturing module 2000 may be configured to manufacture a fertilizer pellet 1 using raw materials provided from a plurality of hoppers (not shown) storing different raw materials.

The pellet manufacturing module 2000 may include a metering ejector 2100, a pulverizer 2200, a mixer 2300, a steamer 2400, and a shaping machine 2500.

The metering ejector 2100 is configured to supply raw materials to each hopper storing a different raw material. For example, when four hoppers from a first hopper to a fourth hopper are provided, the raw materials accommodated in the first hopper to the fourth hopper may be different.

Raw materials may be input from the first to fourth hoppers accommodating different raw materials at varying proportions depending on the type of organic fertilizer 2 to be finally manufactured. In other words, the finally manufactured organic fertilizer 2 may include different mixing ratios of raw materials.

For example, when products of the finally manufactured organic fertilizer 2 are divided into gold products, plus products, alpha products, and export products, the proportions of raw materials input into the first hopper to the fourth hopper in the product manufacturing process may be different.

The metering ejector 2100 configured to provide raw materials to each hopper may selectively supply required raw materials through a raw material monitoring unit (not shown) configured to determine the status of raw materials in each hopper in real time.

For example, the metering ejector 2100 may be provided in a raw material warehouse where various raw materials are stored, and the first to fourth hoppers may be provided in a mixing warehouse that is a space different from the raw material warehouse. In other words, the metering ejector 2100 and the hoppers may be located in different places, and the raw materials supplied from the metering ejector 2100 may be supplied to the hoppers via various transportation means such as a bucket elevator, a conveyor, and the like.

In this way, the user can check the amount of raw materials accommodated in the first to fourth hoppers via the raw material monitoring unit provided in the raw material warehouse, and when a certain amount or less of a raw material is accommodated in the first hopper, the metering ejector 2100 may additionally supply a raw material to the first hopper.

The metering ejector 2100 may be configured so that one metering ejector 2100 supplies raw materials to a plurality of hoppers or one metering ejector 2100 is provided for each hopper.

Meanwhile, the pulverizer 2200 is configured to pulverize the raw materials supplied from the hoppers. In order to effectively mix the raw materials supplied from the hoppers in the mixer 2300, the pulverizer 2200 is configured to pulverize lumpy raw materials into a powder form. In other words, the pulverizer 2200 pulverizes raw materials so that particles thereof are uniform.

The mixer 2300 is configured to mix the raw materials pulverized by the pulverizer 2200.

The mixer 2300 is capable of effectively mixing a plurality of raw materials via various raw material mixing means such as an impeller and the like.

The raw materials mixed in the mixer 230 are supplied to the steamer 2400.

The steamer 2400 is configured to supply moisture to the mixed raw materials. In this case, the amount of moisture supplied to the raw materials via the steamer 2400 may vary depending on products of the finally manufactured organic fertilizer 2.

For example, when the finally manufactured organic fertilizer 2 is in the form of a cylindrical pellet, the steamer 2400 may supply moisture so that the moisture content in the mixed raw materials becomes 16 to 18%. Also, when the finally manufactured organic fertilizer 2 is in the form of a round granule, the steamer 2400 may supply moisture so that the moisture content in the mixed raw materials becomes 20 to 24%.

As described above, the steamer 2400 is configured to supply a larger amount moisture to a granule-type organic fertilizer 2 than a pellet-type organic fertilizer 2. This is intended to prevent the fertilizer pellet 1 from cracking and enable effective shape deformation into a round granule shape during a shaping process into a granule shape in a fertilizer processing unit 3100 to be described below.

Meanwhile, the shaping machine 2500 is configured to shape the raw materials supplied from the steamer 2400 into cylindrical fertilizer pellets 1.

The shaping machine 2500 may include an inner housing 2510, a shaping mesh 2520, a pressing portion 2530, a raw material guide portion 2540, an outer housing 2550, and a cutting portion 2560.

In the inner housing 2510, a raw material accommodating portion 2511 configured to accommodate the raw materials supplied from the steamer 2400 is formed.

The outer housing 2550 is coupled to the inner housing 2510 and provided outside the inner housing 2510. The outer housing 2550 is formed to have an inner diameter that is larger than an outer diameter of the inner housing 2510.

In the outer housing 2550, a supply hole 2551 connected to a raw material transfer pipe 2410 through which the raw materials supplied with moisture from the steamer 2400 are transferred is formed, and thus the raw materials supplied from the steamer 2400 may be guided to the raw material accommodating portion 2511 via the supply hole 2551.

In the shaping mesh 2520, a plurality of extrusion holes 2521 are formed. Accordingly, the raw materials accommodated in the raw material accommodating portion 2511 are pressed toward the outside of the shaping mesh 2520 by the pressing portion 2530 while the inner housing 2510 rotates. In other words, the raw materials passing through the extrusion holes 2521 by the pressing portion 2530 are subjected to extrusion shaping into a cylindrical shape.

The pressing portion 2530 is provided inside the inner housing 2510. The pressing portion 2530 is formed, for example, in the form of a roller and thus allows the raw materials introduced between the shaping mesh 2520 and the pressing portion 2530 to be extruded.

The raw material guide portion 2540 is coupled to the lower part of the frame supporting the pressing portion 2530. The raw material guide portion 2540 is configured to guide the raw materials supplied via the supply hole 2551 to the raw material accommodating portion 2511.

The raw material guide portion 2540 is disposed at an angle relative to the longitudinal direction of the inner housing 2510, and thus the raw materials introduced via the supply hole 2551 during the rotation process of the inner housing 2510 may be effectively supplied to the raw material accommodating portion 2511.

Cutting portions 2560 are coupled to the inside of the outer housing 2550 and disposed to be spaced apart at predetermined intervals along the circumference of the outer housing 2550.

The cutting portion 2560 is configured to cut the cylindrical solid raw material extruded to the outside via the extrusion holes 2521 while the inner housing 2510 and the shaping mesh 2520 rotate in one direction. Therefore, fertilizer pellets 1, which are the cylindrical solid raw material cut by the cutting portion 2560, may be manufactured.

Meanwhile, the fertilizer processing module 3000 is configured to process the fertilizer pellets 1 supplied from the shaping machine 2500 to manufacture various types of organic fertilizer 2.

The fertilizer processing module 3000 may include a fertilizer processing unit 3100, a blower unit 3200, and a packaging machine 3300.

In the fertilizer processing unit 3100, the fertilizer pellets 1 supplied from the shaping machine 2500 are processed into organic fertilizer 2, and the organic fertilizer 2 manufactured from the fertilizer processing unit 3100 may be selectively manufactured as, for example, granular fertilizer, coated granular fertilizer, pelleted fertilizer, and coated pelleted fertilizer.

The fertilizer processing unit 3100 may include a cylindrical rotary housing 3110, a mixing wing 3120, a coating liquid supply unit 3130, a hot air supply unit 3140, and an operation control unit 3150.

The cylindrical rotary housing 3110 forms the exterior of the fertilizer processing unit 3100.

In the cylindrical rotary housing 3110, a hollow processing space 3111 in which the fertilizer pellets 1 are accommodated is formed.

An inlet configured to introduce the fertilizer pellets 1 supplied from the shaping machine 2500 is formed at one end of the cylindrical rotary housing 3110, and an outlet configured to discharge the processed organic fertilizer 2 is formed at the other end of the cylindrical rotary housing 3110.

The fertilizer pellets 1 introduced via the inlet are selectively subjected to shape processing and microorganism coating while moving along the longitudinal direction of the cylindrical rotary housing 3110, and thus desired form of organic fertilizer 2 may be manufactured.

The cylindrical rotary housing 3110 is inclined to form a downward slope from the inlet to the outlet.

The cylindrical rotary housing 3110 may be rotated by the operation of a rotary roller 3112 while being supported on the rotary roller 3112. While the cylindrical rotary housing 3110 rotates, the fertilizer pellets 1 supplied to the processing space 3111 may move along the longitudinal direction of the cylindrical rotary housing 3110. In this process, the fertilizer pellets 1 may be processed into the desired form of organic fertilizer 2.

In this case, the rotary roller 3112 may rotate the cylindrical rotary housing 3110 at a desired rotational speed by power provided from a rotation power unit (not shown).

The hot air supply unit 3140 is coupled to one end of the cylindrical rotary housing 3110. The hot air supply unit 3140 is configured to supply hot air to the processing space 3111.

The hot air supplied from the hot air supply unit 3140 dries the fertilizer pellets 1 supplied to the processing space 3111.

Since the fertilizer pellets 1 manufactured to have a low moisture content through the above-described steamer 2400 are dried by the hot air supplied from the hot air supply unit 3140 within a short period of time, the hardened fertilizer pellets 1 hardly undergo shape deformation while moving along the longitudinal direction of the cylindrical rotary housing 3110.

On the other hand, the fertilizer pellets 1 manufactured to have a high moisture content through the steamer 2400 strike the inner surface of the cylindrical rotary housing 3110 or are crushed or worn due to collisions between the fertilizer pellets 1 while the cylindrical rotary housing 3110 rotates. In this process the cylindrical fertilizer pellets 1 are transformed into round granules. In other words, since it takes a long time to dry the fertilizer pellets 1 manufactured to have a high moisture content, the fertilizer pellets 1 are transformed into granules until the fertilizer pellets 1 are completely dried.

In addition, the operation control unit 3150 may selectively control the operation of the hot air supply unit 3140.

For example, when pellet-shaped organic fertilizer 2 is manufactured, the operation control unit 3150 may control the operation of the hot air supply unit 3140 so that the temperature and intensity of hot air supplied from the hot air supply unit 3140 increase.

On the other hand, when granular organic fertilizer 2 is manufactured, the operation control unit 3150 may control the operation of the hot air supply unit 3140 so that the temperature and intensity of hot air supplied from the hot air supply unit 3140 decrease.

In this way, the operation control unit 3150 may selectively control the temperature and intensity of hot air supplied from the hot air supply unit 3140 and also selectively control operation conditions so that the organic fertilizer 2 is effectively manufactured with the desired form.

In addition, the cylindrical rotary housing 3110 is provided with the mixing wing 3120.

The mixing wing 3120 is configured to effectively supply the hot air supplied from the hot air supply unit 3140 to the fertilizer pellets 1.

Mixing wings 3120 protrude at predetermined intervals along the circumference of the cylindrical rotary housing 3110. Also, the mixing wings 3120 may be disposed at predetermined intervals along the longitudinal direction of the cylindrical rotary housing 3110.

The mixing wings 3120 are configured to mix the fertilizer pellet 1 accommodated in the processing space 3111 while the cylindrical rotary housing 3110 rotates and to effectively supply hot air between the plurality of fertilizer pellets 1. Therefore, the drying efficiency of the fertilizer pellets 1 may further increase.

The coating liquid supply unit 3130 is coupled to one end of the cylindrical rotary housing 3110.

The coating liquid supply unit 3130 is configured to spray a microorganism coating liquid to the processing space 3111 so that the outer surface of the fertilizer pellet 1 is coated with microorganisms.

The coating liquid supply unit 3130 may be selectively operated by the operation control unit 3150. In other words, when the finally manufactured organic fertilizer 2 needs to be coated with microorganisms, the operation control unit 3150 may operate the coating liquid supply unit 3130 to coat the outer surface of the fertilizer pellet 1 with microorganisms. As such, the coated organic fertilizer 2 may be manufactured as coated granular fertilizer and coated pelleted fertilizer.

The coating liquid supply unit 3130 may control the spraying of a microorganism coating liquid on the fertilizer pellet 1 to coat the outer surface of a finally manufactured organic fertilizer 2 with the desired microorganism coating liquid.

The coating liquid supply unit 3130 may include a coating liquid tank 3131, a spray nozzle 3132, and a metering pump 3133.

A plurality of coating liquid tanks 3131 may be provided. In other words, each coating liquid tank 3131 may accommodate a different microorganism coating liquid.

Each of these coating liquid tanks 3131 are connected to the metering pump 3133, and the microorganism coating liquid may be supplied to the spray nozzle 3132 by the operation of the metering pump 3133.

Valves (not shown) may be provided in connection pipes 3134 that connect the coating liquid tanks 3131 and the metering pump 3133, and the operation control unit 3150 may selectively control the opening and closing of the valves.

As the operation control unit 3150 controls the valves, the organic fertilizer 2 may be coated with microorganisms in various ways. For example, the operation control unit 3150 may control the valves so that only a first microorganism coating liquid accommodated in a first coating liquid tank is sprayed onto the fertilizer pellets 1 and that only a second microorganism coating liquid accommodated in a second coating liquid tank is sprayed onto the fertilizer pellets 1. Alternatively, the operation control unit 3150 may control the valves so that a mixed microorganism coating liquid in which the first microorganism coating liquid and the second microorganism coating liquid are mixed is sprayed onto the fertilizer pellets 1. In the case of the mixed microorganism coating liquid, the mixing ratio of the first microorganism coating liquid and the second microorganism coating liquid may be selectively controlled by adjusting the degree of opening and closing of the valves provided in each connection pipe 3134.

In the present invention, an example in which two coating liquid tanks 3131 are provided is described, but the number of coating liquid tanks 3131 is not necessarily limited to 2, and liquid tanks may be provided in various numbers.

The metering pump 3133 is configured to supply a microorganism coating liquid to the spray nozzle 3132 at a predetermined pressure. The operation of the metering pump 3133 may also be controlled by the operation control unit 3150.

The spray nozzle 3132 is connected to the metering pump 3133 and configured to spray a microorganism coating liquid supplied from the metering pump 3133 onto the fertilizer pellets 1.

The spray nozzle 3132 is provided at one end of the cylindrical rotary housing 3110 and disposed in the processing space 3111. The spray nozzle 3132 is provided at one end of the cylindrical rotary housing 3110 and thus sprays a microorganism coating liquid onto the outer surface of the fertilizer pellets 1 supplied to the cylindrical rotary housing 3110 through the inlet. In other words, the spray nozzle 3132 is configured to spray a microorganism coating liquid onto the fertilizer pellet 1 accommodated in one side of the cylindrical rotary housing 3110.

A plurality of spray holes (not shown) are formed in the spray nozzle 3132, and thus the microorganism coating liquid sprayed from the spray holes may be sprayed onto the fertilizer pellets 1 accommodated in one side of the cylindrical rotary housing 3110.

Here, the spray nozzle 3132 may have a length of ⅓ or less relative to the length of the cylindrical rotary housing 3110 and allows a microorganism coating liquid to be sprayed onto the fertilizer pellets 1. This is intended to effectively dry the microorganism coating liquid by the hot air supplied from the hot air supply unit 3140 while the fertilizer pellets 1, whose outer surface is coated with the microorganism coating liquid, move to the other end of the cylindrical rotary housing 3110.

In other words, when the length of the spray nozzle 3132 exceeds ⅓ of the length of the cylindrical rotary housing 3110, the microorganism coating liquid applied on the outer surface of the fertilizer pellets 1 may not be appropriately dried.

Therefore, the spray nozzle 3132 is formed to have a length of ⅓ or less relative to the length of the cylindrical rotary housing 3110. In order to effectively dry the microorganism coating liquid, it is more preferable to form the spray nozzle 3132 to have a length of ¼ or less relative to the length of the cylindrical rotary housing 3110.

In this way, the organic fertilizer 2 manufactured as granular fertilizer, coated granular fertilizer, pelleted fertilizer, and coated pelleted fertilizer in the fertilizer processing unit 3100 is supplied to the blower unit 3200.

The blower unit 3200 is configured to supply room-temperature air and cool the organic fertilizer 2 that has been dried by heating to a certain temperature or higher by the hot air supply unit 3140.

In addition, the packaging machine 3300 is configured to package the organic fertilizer 2 supplied from the blower unit 3200 according to each product.

The effects of the above-described organic fertilizer manufacturing system according to the present invention will be described as follows.

According to the present invention, the fertilizer processing unit can manufacture various types of organic fertilizer. For example, the fertilizer processing unit can selectively manufacture organic fertilizer as granular fertilizer, coated granular fertilizer, pelleted fertilizer, and coated pelleted fertilizer.

Since the fertilizer processing unit is a single device and can manufacture various types of organic fertilizer, the configuration and work process of the organic fertilizer manufacturing system can be simplified.

However, it is to be understood that the effects of the present invention are not limited to the above-described effects but include all effects deducible from the configuration described in the detailed description of the present invention or in the claims.

The above is only a preferred embodiment of the present invention, and the scope of the present invention is not limited by the scope of description of this embodiment.

The foregoing description of the present invention is for illustrative purposes, and it will be understood by those skilled in the art to which the present invention pertains that the present invention can be easily modified into other specific forms without changing the technical spirit or essential features described in the present invention. Therefore, it should be understood that the embodiments described above are only illustrative in all aspects and not restrictive. For example, each of the constituents described as being one combined entity may be implemented separately, and similarly, constituents described as being separate entities may be implemented in a combined form.

It should be understood that the scope of the present invention is defined by the following claims and that all changes or modifications derived from the meaning and scope of the claims and their equivalents are included in the scope of the present invention.

1. An organic fertilizer manufacturing system comprising:
a pellet manufacturing module configured to manufacture fertilizer pellets from a plurality of hoppers storing different raw materials; and
a fertilizer processing module configured to process the fertilizer pellets supplied from the pellet manufacturing module to manufacture organic fertilizer,
wherein a fertilizer processing unit provided in the fertilizer processing module is configured to selectively manufacture the organic fertilizer as granular fertilizer, coated granular fertilizer, pelleted fertilizer, and coated pelleted fertilizer.

2. The organic fertilizer manufacturing system of claim 1, wherein the fertilizer processing unit includes:
a cylindrical rotary housing provided with an inlet configured to introduce the fertilizer pellets supplied from the pellet manufacturing module at one end and an outlet configured to discharge the selectively processed organic fertilizer at the other end;
mixing wings provided at predetermined intervals along the circumferential direction and longitudinal direction of the cylindrical rotary housing;
a coating liquid supply unit coupled to one end of the cylindrical rotary housing and configured to spray a coating liquid inside the cylindrical rotary housing;
a hot air supply unit coupled to one end of the cylindrical rotary housing and configured to supply hot air into the cylindrical rotary housing; and
an operation control unit configured to control the operation of the coating liquid supply unit and the hot air supply unit.

3. The organic fertilizer manufacturing system of claim 2, wherein the operation control unit is configured to control the operation of the coating liquid supply unit so that a desired microorganism coating liquid is sprayed onto the fertilizer pellets and the outer surface of the organic fertilizer is coated with microorganisms.

4. The organic fertilizer manufacturing system of claim 2, wherein the operation control unit is configured to control the operation of the hot air supply unit so that the temperature and intensity of hot air supplied to the fertilizer pellets are adjusted and the organic fertilizer with a desired form is manufactured.

5. The organic fertilizer manufacturing system of claim 2, wherein the coating liquid supply unit includes:
coating liquid tanks each accommodating a different microorganism coating liquid;
a spray nozzle disposed in a processing space accommodating the fertilizer pellets in the cylindrical rotary housing and configured to spray the microorganism coating liquid supplied from the coating liquid tank into the processing space; and
a metering pump connected to the coating liquid tank and configured to supply the microorganism coating liquid accommodated in the coating liquid tank to the spray nozzle, and
the operation control unit is configured to control the supply of the microorganism coating liquid from each coating liquid tank to the spray nozzle.

6. The organic fertilizer manufacturing system of claim 5, wherein the spray nozzle is disposed at one end of the cylindrical rotary housing, and the length of the spray nozzle is ⅓ or less of the length of the cylindrical rotary housing.

7. The organic fertilizer manufacturing system of claim 1, wherein the pellet manufacturing module includes:
a metering ejector configured to supply raw materials to a plurality of hoppers storing different raw materials;
a pulverizer configured to pulverize the raw materials supplied from the hopper;
a mixer configured to mix the raw materials pulverized by the pulverizer;
a steamer configured to supply moisture to the raw materials mixed by the mixer; and
a shaping machine configured to shape the raw materials supplied from the steamer into the fertilizer pellets, and
the fertilizer processing module further includes:
a blower unit configured to cool the organic fertilizer manufactured by the fertilizer processing unit; and
a packaging machine configured to package the organic fertilizer supplied from the blower unit.
